(19) United States
(12) Patent Application Publication
(10) Pub. No.: US 2025/0363181 A1
(43) Pub. Date: Nov. 27, 2025

(54) SYSTEMS AND METHODS FOR DOWNLOADING AND DISPLAYING A MOBILE APPLICATION (APP) TO A MOBILE DEVICE

(71) Applicant: THE MOBILE APP COMPANY, SAINT AUGUSTINE, FL (US)

(72) Inventor: Helen Kramer, SAINT AUGUSTINE, FL (US)

(73) Assignee: THE MOBILE APP COMPANY, SAINT AUGUSTINE, FL (US)

(21) Appl. No.: 19/216,524

(22) Filed: May 22, 2025

Related U.S. Application Data
(60) Provisional application No. 63/650,543, filed on May 22, 2024.

(51) Int. Cl. G06F 16/955; G06F 8/61; G06Q 30/0601

(52) U.S. Cl. CPC G06F 16/9554; G06F 8/61; G06Q 30/0641

(57) ABSTRACT

A system for downloading and displaying a mobile application includes at least one electronic processor programmed to receive a business identification (ID) associated with a Quick Response (QR) code the QR code encoding a link to an app page generated from a user interface (UI) template associated with the business ID, the QR code being configured for scanning by a mobile device; search a database for the UI template associated with the business ID from a set of UI templates stored in the database; control the mobile device to automatically open the link to the app page generated from the UI template associated with the business ID using the app on the mobile device; and control the mobile device to prevent the mobile device from displaying UI templates associated with business IDs different from the business ID associated with the displayed UI template.

### CROSS-REFERENCE TO RELATED APPLICATION

This application claims the benefit of the filing date under 35 U.S.C. § 119 (e) of Provisional Patent Application Serial Number No. 63/650,543, filed May 22, 2024, which is hereby incorporated by reference in its entirety for all purposes.

### FIELD

The following relates generally to mobile device arts, Quick Response (QR) code arts, mobile application (“app”) download arts, mobile app display arts, and related arts.

### BACKGROUND

Pages containing QR codes are becoming more popular in public places, such as restaurants, stores, and malls. From menus to store fronts, consumers more often have to use a camera on their mobile devices (e.g., cell phones) to scan a QR code to view information (e.g., a menu at a restaurant, items on sale at a store, and so forth). Oftentimes, the scanned QR code allows a user to download an app for the restaurant or store onto their cellphone.

However, connectivity issues with mobile devices in such public places can prevent users from downloading the corresponding app. As a result, users may not be able to access the information in the QR code, and thus may not go to the restaurant or stores with these QR codes.

On the app developer side, it can be expensive for small business owners of such restaurants and stores to create and develop an app. Furthermore, constant updates of the apps, and approval from app store vendors (e.g., Apple App Store or Google Play), are required.

The following discloses new and improved systems and methods to overcome these problems and others.

### SUMMARY

In one disclosed aspect, a system for downloading a mobile application (“app”) includes at least one electronic processor programmed to receive a business identification (ID) associated with a Quick Response (QR) code the QR code encoding a link to an app page generated from a user interface (UI) template associated with the business ID, the QR code being configured for scanning by a mobile device; search a database for the UI template associated with the business ID from a set of UI templates stored in the database; control the mobile device to automatically open the link to the app page generated from the UI template associated with the business ID using the app on the mobile device; and control the mobile device to prevent the mobile device from displaying UI templates associated with business IDs different from the business ID associated with the displayed UI template.

In another disclosed aspect, a non-transitory computer readable medium stores instructions implemented on a mobile device having at least one electronic processor and a display device. The at least one electronic processor is programmed to scan a Quick Response (QR) code with the mobile device, the QR code encoding a link to an application (“app”) page generated from a user interface (UI) template associated with a business identification (ID); automatically open the link to the app page from the UI template associated with business ID; automatically open the app on the mobile device and display the app page on the mobile device; and prevent the mobile device from displaying UI templates associated with business IDs different from the business ID associated with the displayed UI template.

In another disclosed aspect, a method for downloading an app includes: with a server (12), receiving the business ID associated with the scanned QR code; with the server, determining a manufacturer of the mobile device that has scanned the QR code; with the mobile device, determining whether the app is downloaded onto the mobile device; with the server, in response to an absence of the app being downloaded onto the mobile device, controlling the mobile device to automatically open the link to an app download page using an app store on the mobile device; with the mobile device, receiving an input from a user to download the app onto the mobile device using the app store; with the mobile device, automatically opening the app on the mobile device and displaying the app page generated from the UI template on the mobile device; and with the server, controlling the mobile device to prevent the mobile device from displaying UI templates associated with business IDs different from the business ID associated with the displayed UI template.

One advantage resides in automatically directing an app download page to a mobile device used to scan a QR code.

Another advantage resides in providing a mobile app that allows business owners to have their own mobile presence in the app store without having to pay a developer to submit their mobile app through all the approval channels.

Another advantage resides in, when an app download page is directed from a database to a mobile device for download by scanning a QR code, preventing access by the mobile device to other app download pages stored in the database.

Another advantage resides controlling a mobile device, when the app page is open on the mobile device, to restrict display, on the mobile device, of app pages rendered by a user interface (UI) template associated with a business ID.

A given embodiment may provide none, one, two, more, or all of the foregoing advantages, and/or may provide other advantages as will become apparent to one of ordinary skill in the art upon reading and understanding the present disclosure.

### BRIEF DESCRIPTION OF THE DRAWINGS

The disclosure may take form in various components and arrangements of components, and in various steps and arrangements of steps. The drawings are only for purposes of illustrating the preferred embodiments and are not to be construed as limiting the disclosure.

FIG. 1 diagrammatically shows a hospital asset logistics optimization system according to one aspect.

FIG. 2 shows exemplary flow chart operations of the system of FIG. 1.

### DETAILED DESCRIPTION

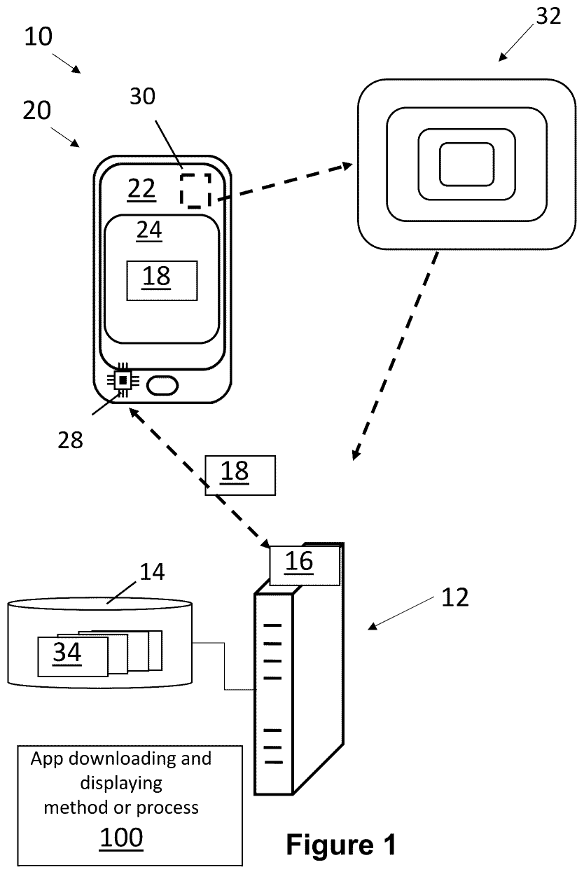

With reference to FIG. 1, an illustrative system 10 for downloading a mobile application (“app”) onto a mobile device of a user is diagrammatically shown. As shown in FIG. 1, the system 10 includes a server 12 implementing one or more databases 14, and at least one electronic processor 16. The at least one electronic processor 16 of the server 12 is configured to use data received to download (i.e., loaded on, and executable on, and stored on) a mobile application program (hereinafter referred to as an “app”) 18 onto a mobile device 20 of a user (e.g., an illustrative cellular telephone 20, or a tablet computer, personal data assistant or PDA, and/or so forth).

The database(s) 14 can be stored on one or more non-transitory storage media which may, by way of non-limiting illustrative example, include one or more of a magnetic disk, RAID, or other magnetic storage medium; a solid state drive, flash drive, electronically erasable read-only memory (EEROM) or other electronic memory; an optical disk or other optical storage; various combinations thereof; or so forth; and may be for example a network storage accessible by the server 12, an internal hard drive of a workstation (not shown), various combinations thereof, or so forth. It is to be understood that any reference to a non-transitory medium or media herein is to be broadly construed as encompassing a single medium or multiple media of the same or different types.

Likewise, the electronic processor 16 may be embodied as a single electronic processor or as two or more electronic processors. The at least one electronic processor 16 is operatively connected with the database(s) 14. The electronic processor 16 can be any suitable processor, typically a single server computer or a plurality of server computers (e.g. interconnected to form a server cluster, cloud computing resource, or so forth), although the electronic processor 16 may be alternatively or additionally embodied as a computing device (e.g., typically a workstation computer, or more generally a computer, although another form factor such as a tablet, a smartphone, and so forth is also contemplated). While a single server 12 is illustrated, it will be appreciated that the desired computing capacity may be obtained by way of a plurality of cooperating server computers, e.g. a computing cluster, cloud computing resource, or so forth, and it is to be understood that the server computer 12 encompasses such multi-computer embodiments.

The mobile device 20 can include a display device (i.e., a touch-sensitive screen) 22 that provides a system user interface 24 for display on a display device 22 of the mobile device 20 for displaying the app 18. The mobile device 20 also includes at least one electronic processor 28. Upon receiving a link from the server 12, the electronic processor 28 is programmed to provide the system user interface 24 on the display device 22 for the user to download the app 18. The mobile device 20 also includes a built-in camera 30 for scanning a quick response (QR) code 32.

The system 10 is configured to perform a method or process 100 for downloading and displaying a mobile application (“app”). The database(s) 14 stores instructions which are readable and executable by the at least one electronic processor 16, and the mobile device 20 stores instructions which are readable and executable by the at least one electronic processor 28 and to perform disclosed operations including performing the method or process 100 for downloading an app. In some examples, the method 100 may be performed at least in part by cloud processing.

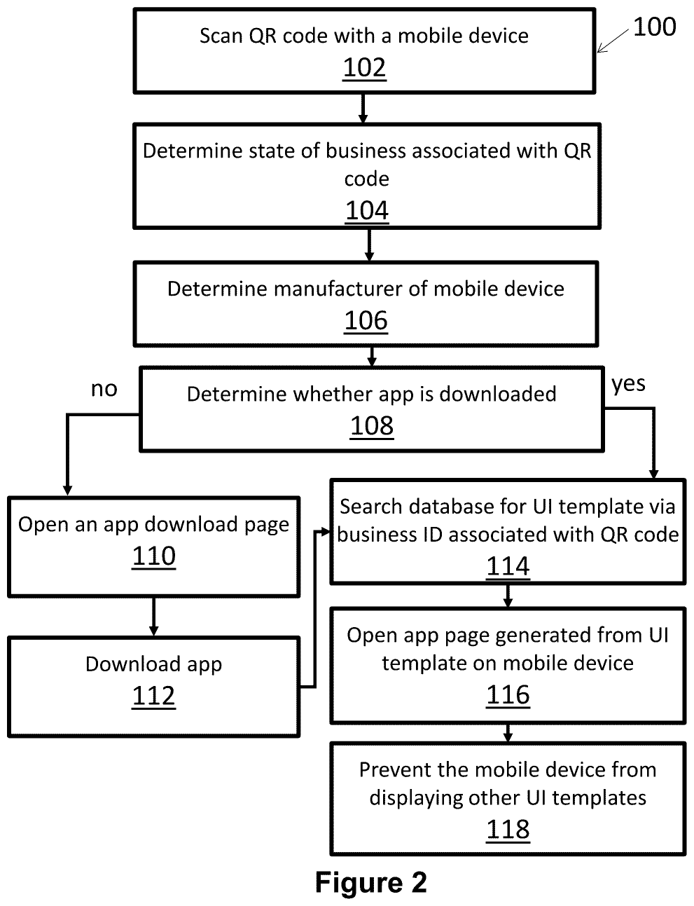

With reference to FIG. 2, and with continuing reference to FIG. 1, an illustrative embodiment of an instance of the method 100 executable by the at least one electronic processor 16 is diagrammatically shown as a flowchart. The following also includes an example of the method 100 in the context of downloading and displaying the app 18 as an app for a food or culinary business, in particular in the context of a food truck.

At an operation 102, a user (not shown) uses the mobile device 20 to scan a QR code 32. As shown in FIG. 1, the QR code 32 can be placed on, for example, a piece of paper located on a food truck (not shown—i.e., taped to an outer wall of the food truck) for the business associated with the QR code 32 and the food truck (i.e., “Fae's BBQ”). The user can position the mobile device 20 so that the camera 30 is aligned with the QR code 32. Once aligned, the camera 30 then automatically scans the QR code 32. The server 12 can search the database(s) 14 to find the business ID associated with the scanned QR code 32 with a deep link. When the QR code 32 is scanned by the camera 30, the business ID associated with the QR code 32 (i.e., Fae's BBQ) is transmitted to, and received by, the server 12.

At an operation 104, the server 12 is programmed to determine a state of the business ID associated with the QR code 32 (i.e., “is Fae's BBQ an actual business?” and “does Fae's BBQ have a UI template 34 stored in the database 14?”). If the server 12 determines that the state of the business ID is valid, then the server 12 connects to the mobile device 20 to obtain or gain control of the electronic processor 28 so that the app 18 can be opened or downloaded onto the mobile device 20.

At an operation 106, a manufacturer of the mobile device 20 that has scanned the QR code 32 (i.e., “is the mobile device manufactured by Apple or Samsung?”) is determined. A third-party app can be used to determine the manufacturer of the mobile device 20.

At an operation 108, based on the determined manufacturer, the mobile device 20 attempts to open the app 18 via the deep link and determine whether the app 18 is downloaded on the mobile device 20.

At an operation 110, in response to an absence of the app 18, a static web page is opened on the mobile device 20, allowing the user to open a corresponding app store (not shown) of the mobile device 20 so that the app 18 can be downloaded to the mobile device 20. To do so, a link can be used in a webpage with specific protocols for opening an app's page in the store (e.g., for an Apple phone, a link such as “itms-apps://” can be used). The static web page is used to allow the mobile device 12 to automatically open, using the app store, an app download page to the app 18 (i.e., TMAC) for the user to download to the mobile device 20. This can be performed using any suitable process (i.e., OneLink.to or Uniqode).

At an operation 112, the mobile device 20 then receives an input from the user (i.e., a finger tap on the display 22) to download the app 18 onto the mobile device 20.

At an operation 114, the server 12 is programmed to search the database 14 for a user interface (UI) template 34 for the business associated with the QR code 32 (i.e., Fae's BBQ). To do so, the server 12 maintains the database 14 of a plurality of user interface (UI) templates 34 for a plurality of businesses. The QR code 32 encodes a link to an app page generated from one or more user interfaces (UI) template 34 associated with an identification of the business ID and the QR code 32. Each UI template 34 comprises, for example, layout structures, navigation paths, data content and visual configurations. The data content and visual configurations are dynamic and may be customized according to a business's branding (e.g., customized logo, color scheme, font, and so forth), allowing businesses to update the data content and visual configurations effortlessly. Upon receiving the business ID associated with the QR code 32 (i.e., Fae's BBQ), the server 12 searches the database 14 to determine if the business ID associated with the QR code 32 has a corresponding UI template 34 stored in the database 14. To do so, the app 18 on the mobile device 20 parses the deep link and sends an application program interface (API) request to the server 12 asking for the UI template 34 programmed to match the business ID associated with the scanned QR code 32.

At an operation 116, the mobile device 20 automatically opens the app 18 and displays the app page rendered by the UI template 34. To do so, the server 12 provides a response (i.e., JSON response) to the API request, and the app 18 on the mobile device 20 uses the response to render the app page dynamically on the mobile device 20.

At an operation 118, when the app page for the app 18 is open on the mobile device 20, the server 12 is programmed to control the mobile device 20 to restrict the mobile device 20 from displaying app pages rendered by the UI template 34 associated with the business ID, and prevent the mobile device 20 from displaying app pages rendered by other UI templates 34. This is achieved by the server 12 defaulting the app 18 to the UI template 34 matching the business ID associated with the scanned QR code 32. Advantageously, the user may have the impression that the app 18 is dedicated to a desired business (i.e., Fae's BBQ). When a second QR code 32 is scanned by the mobile device 20, the app 18 is defaulted to a second UI template 34 programmed to match a second business ID associated with the second scanned QR code 32. When the app page for the app 18 is closed on the mobile device 20, the server 12 is programmed to stop controlling the mobile device 20 to restrict the mobile device 20 from displaying app pages rendered by the UI template 34 associated with the business ID. In some embodiments, the user can then provide another input indicative of a selection of a portion of the displayed app 18 on the mobile device 20 (i.e., using the app 18 to search for the food truck associated with the QR code 32). The app 18 may include additional features, such as accepting orders, pushing notifications, menu browsing and showing real-time business locations, which may be integrated with each of the UI templates 34. In some embodiments, when a QR code 32 is not scanned, the app 18 may display previously scanned QR codes 32 associated with other businesses having UI templates 34 stored in the database 14. Once a business listed or displayed on the mobile device 20 is selected by the user, the app 18 is defaulted to the UI template 34 associated to the business ID of the selected business.

Advantageously, the disclosed system 10 eliminates the need for individual businesses to built separate apps, which minimizes the effort and cost for updating the apps. At the same time, the disclosed system 10 provides customers the impression that the app is dedicated to the business.

The app 18 may be downloaded to the mobile device 20 from an app store accessed via a Wi-Fi, cellular, or other wireless communication network. In a suitable embodiment, the app 18 is represented on the home screen or applications screen of the mobile device 20 as an app icon (i.e. a small square, round, or other compact graphical element representing the app 18) and the user launches (i.e. initiates running of) an instance of the app 18 on the device 20 by touching the icon on the (touch-sensitive) screen 22 of the mobile device 20.

The disclosure has been described with reference to the preferred embodiments. Modifications and alterations may occur to others upon reading and understanding the preceding detailed description. It is intended that the disclosure be construed as including all such modifications and alterations insofar as they come within the scope of the appended claims or the equivalents thereof.

1. A system (10) for downloading and displaying a mobile application (“app”) (18), the system comprising:
at least one electronic processor (16) programmed to:
receive a business identification (ID) associated with a Quick Response (QR) code (32), the QR code encoding a link to an app page generated from a user interface (UI) template (34) associated with the business ID, the QR code being configured for scanning by a mobile device (20);
search a database (14) for the UI template associated with the business ID from a set of UI templates stored in the database;
control the mobile device to automatically open the link to the app page generated from the UI template associated with the business ID using the app on the mobile device; and
control the mobile device to prevent the mobile device from displaying UI templates associated with business IDs different from the business ID associated with the displayed UI template.

2. The system (10) of claim 1, wherein the at least one electronic processor (16) is programmed to receive the business ID associated with the QR code (32) by a scan of the QR code using a camera (30) of the mobile device (20).

3. The system (10) of claim 1, wherein the at least one electronic processor (16) is programmed to search the app page of the UI template for the business associated with the QR code (32) from the set of UI templates stored in the database (14) by:
matching the scanned QR code with the link of the app page of the business associated with the QR code.

4. The system (10) of claim 1, wherein the at least one electronic processor (16) is programmed to:
determine a manufacturer of the mobile device (20) that has scanned the QR code (32); and
open an app store on the mobile device, the app store being opened based on the manufacturer of the mobile device.

5. The system (10) of claim 1, wherein the at least one electronic processor (16) is programmed to:
determine a state of the business associated with the QR code (32); and
if the state of the business is determined as valid, control the mobile device (20) to download and store the app (18).

6. The system (10) of claim 5, wherein the at least one electronic processor (16) is programmed to determine the state of the business associated with the QR code (32) using a deep link.

7. The system (10) of claim 1, wherein the at least one electronic processor (16) is programmed to control the mobile device (20) to prevent the mobile device from displaying UI templates associated with business IDs different from the business ID associated with the displayed UI template by:
defaulting to the UI template associated with the business ID and the QR code (32).

8. The system (10) of claim 7, wherein the at least one electronic processor (16) is programmed to:
when a second QR code (32) is scanned by the mobile device (20), receiving a second business ID associated with the second QR code; and
defaulting to a second UI template associated with the second business ID.

9. The system (10) of claim 1, wherein the at least one electronic processor (16) is programmed to:
maintain a database (14) of UI templates (34) for a plurality of businesses.

10. A non-transitory computer readable medium storing instructions implemented on a mobile device (20) having at least one electronic processor (28) and a display device (22), wherein the at least one electronic processor is programmed to:
scan a Quick Response (QR) code (32) with the mobile device (20), the QR code encoding a link to an application (“app”) page generated from a user interface (UI) template (34) associated with a business identification (ID);
automatically open the link to the app page from the UI template associated with business ID;
automatically open the app on the mobile device and display the app page on the mobile device; and
prevent the mobile device from displaying UI templates associated with business IDs different from the business ID associated with the displayed UI template.

11. The non-transitory computer readable medium of claim 10, wherein the at least one electronic processor (28) is programmed to:
download and store the app (18) onto the mobile device (20) via an app store.

12. The non-transitory computer readable medium of claim 11, wherein the at least one electronic processor (28) is programmed to download and store the app (18) onto the mobile device (20) via an app store by:
downloading and storing the app based on a determination of a state of the business associated with the business ID to be valid.

13. The non-transitory computer readable medium of claim 10, wherein the at least one electronic processor (28) is programmed to:
control a camera (30) of the mobile device (20) to scan the QR code (32).

14. The non-transitory computer readable medium of claim 10, wherein the at least one electronic processor (28) is programmed to automatically open the link to the app page from the UI template (34) associated with business ID by:
opening an app store on the mobile device (20) based on the manufacturer of the mobile device.

15. The non-transitory computer readable medium of claim 10, wherein the at least one electronic processor (28) is programmed to prevent the mobile device (20) from displaying UI templates (34) associated with business IDs different from the business ID associated with the displayed UI template by:
defaulting the app (18) to the UI template associated with the business ID.

16. The non-transitory computer readable medium of claim 15, wherein the at least one electronic processor (28) is programmed to:
when a second QR code (32) is scanned by the mobile device (20), defaulting the app (18) to a second UI template associated with the scanned second QR code.

17. A method (100) for downloading and displaying an application (“app”) (18), comprising:
with a camera (30) of a mobile device (20), scanning a Quick Response (QR) code (32), the QR code encoding a link to an application (“app”) page (34) generated from a user interface (UI) template associated with a business identification (business ID);
with a server (12), receiving the business ID associated with the scanned QR code;
with the server, determining a manufacturer of the mobile device that has scanned the QR code;
with the mobile device, determining whether the app is downloaded onto the mobile device;
with the server, in response to an absence of the app being downloaded onto the mobile device, controlling the mobile device to automatically open the link to an app download page using an app store on the mobile device;
with the mobile device, receiving an input from a user to download the app onto the mobile device using the app store;
with the mobile device, automatically opening the app on the mobile device and displaying the app page generated from the UI template on the mobile device; and
with the server, controlling the mobile device to prevent the mobile device from displaying UI templates associated with business IDs different from the business ID associated with the displayed UI template.

18. The method (100) of claim 17, further comprising:
with the mobile device (20), downloading and storing the app onto the mobile device.

19. The method (100) of claim 17, wherein automatically opening the app (18) on the mobile device (20) and displaying the app page on the mobile device includes:
defaulting the app (18) to the UI template associated with the business ID.

20. The method (100) of claim 17, wherein downloading and storing the app (18) for the business associated with the QR code (32) onto the mobile device (20) includes:
determining a state of the business associated with the QR code.
